(19) United States
(12) Patent Application Publication
(10) Pub. No.: US 2009/0178937 A1
(43) Pub. Date: Jul. 16, 2009

(54) ANALYTE MEASUREMENT METER OR SYSTEM INCORPORATING AN IMPROVED MEASUREMENT CIRCUIT

(76) Inventor: David William Taylor, City Alloa (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/719,514

(22) PCT Filed: Dec. 29, 2005
(86) PCT No.: PCT/GB2005/005106

§ 371 Date: Aug. 2, 2007

Related U.S. Application Data
(60) Provisional application No. 60/640,680, filed on Dec. 29, 2004.

(51) Int. Cl. G01N 27/416

(52) U.S. Cl. 205/792; 204/406

(57) ABSTRACT

Many aspects of the invention will be apparent from the following paragraphs and detailed description some of which are as follows. In one example, the invention includes a circuit for measuring an analyte or indicator in a body fluid sample including a reference voltage circuit, at least one measurement line, a result line, a buffering circuit between the voltage reference circuit and the measurement line wherein the buffering circuit comprises at least one operational amplifier the output of which is connected to the result line. The circuit may be a glucose concentration measurement circuit delivering the glucose concentration in a body fluid such as for example blood, plasma, interstitial fluid, urine. The circuit may further form part of a meter or system for measuring glucose concentration in a body fluid.

### BACKGROUND OF INVENTION

1. Field of the Invention

The invention relates to an analyte measurement meter and/or system incorporating an improved measurement circuit, for use for example in measuring an analyte or indicator in a fluid sample for example the glucose concentration in body fluid, such as blood, urine, plasma or interstitial fluid.

2. Background to the Invention

Meters or devices for measuring an analyte or indicator, e.g. glucose, HbA1c, lactate, cholesterol, in a fluid such as a body fluid, e.g. blood, plasma, interstitial fluid (ISF), urine, typically make use of disposable test sensors. A test sensor that is specific for the analyte or indicator of interest may be inserted within a connector in the meter or system, or be delivered to a test location from within the meter or system. The test sensor becomes physically and electrically connected with a measuring circuit. A sample, for example blood, plasma, interstitial fluid (ISF) or urine, will typically contain numerous soluble or solubilised components, one of which will be the analyte or indicator of interest. An example user group that might benefit from the use of such a meter or system are those affected with diabetes and their health care providers.

### SUMMARY OF THE INVENTION

Many aspects of the invention will be apparent from the following paragraphs and detailed description some of which are as follows. In one example, the invention includes a circuit for measuring an analyte or indicator in a body fluid sample including a reference voltage circuit, at least one measurement line, a result line, a buffering circuit between the voltage reference circuit and the measurement line wherein the buffering circuit comprises at least one operational amplifier the output of which is connected to the result line. The circuit may be a glucose concentration measurement circuit delivering the glucose concentration in a body fluid such as for example blood, plasma, interstitial fluid, urine. The circuit may further form part of a meter or system for measuring glucose concentration in a body fluid.

### BRIEF DESCRIPTION OF THE DRAWINGS

A better understanding of the features and advantages of the present invention will be obtained by reference to the following detailed description that sets forth illustrative embodiments by way of example only, in which the principles of the invention are utilized, and in the accompanying drawings of which:

FIG. 1 shows a block diagram of a prior art meter.

FIG. 2 shows a schematic view of a system incorporating for example a meter and strip according to an embodiment of the invention.

FIG. 3 shows a block diagram of a meter according to an embodiment of the invention.

FIG. 4 shows a block diagram of a meter or system incorporating an analyte testing, module (e.g. a blood glucose module) and a separate application module for connecting to the analyte testing module and comprising additional components or functions, according to an embodiment of the invention;

FIG. 5 shows a more detailed block diagram of a meter or system incorporating an analyte measurement module (e.g. a blood glucose module) and a separate application module according to an embodiment of the invention;

FIG. 6 shows a circuit block diagram of a blood glucose meter or system incorporating a blood glucose module and integral application module according to an embodiment of the invention;

FIGS. 7A, 7B, 7C and 7D show a detailed circuit diagram of a blood glucose module according to an example embodiment of the invention.

FIGS. 8A, 8B, 8C and 8D show a more detailed circuit diagram of a blood glucose meter such as that seen in FIG. 7.

### DETAILED DESCRIPTION OF THE DRAWINGS

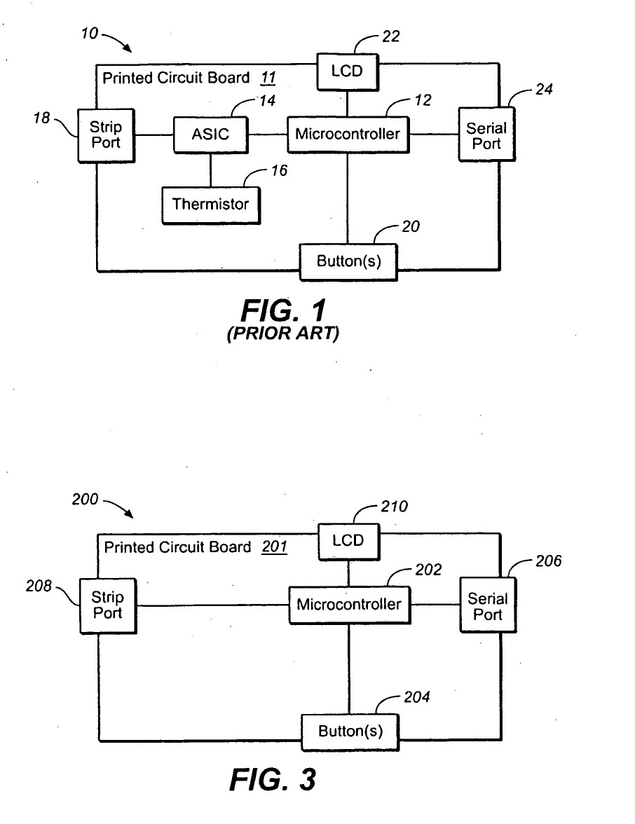

FIG. 1 shows a prior art meter 10 including a printed circuit board (PCB) 11, a microcontroller 12, an application specific integrated circuit (ASIC) 14, a thermistor 16, a strip port 18, button(s) 20, a display 22 and a serial port (data jack) 24.

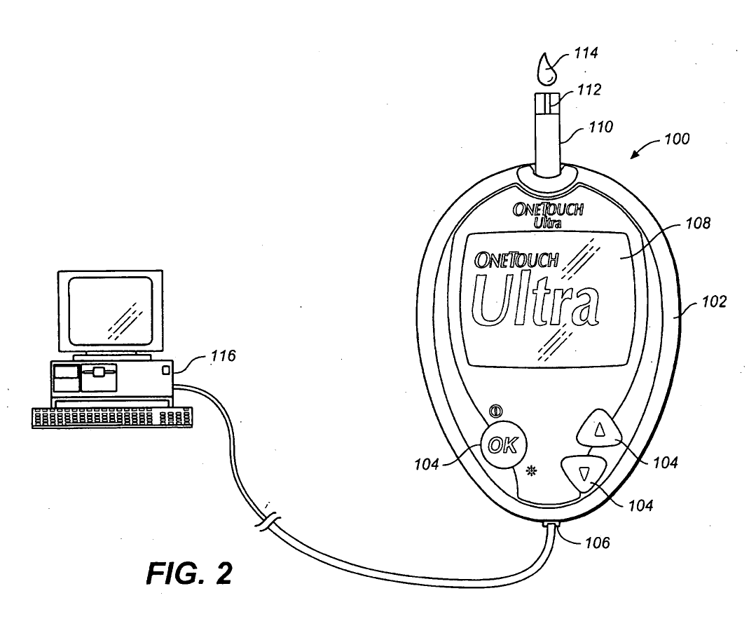

FIG. 1 shows an example meter 10 including an ASIC 14 and a thermistor 16. Strip port 18 is designed to receive a test sensor such as a test strip. ASIC 14 converts analogue signals from the strip (item 110 shown in FIG. 2) via the strip port 18 and thermistor 16 into digital signals. Thermistor 16 is an off-the-shelf electronic component the resistance of which changes with ambient temperature. Display 22 is a customised segmented display. Microcontroller 12 contains software designed to convert the digital signals from the ASIC 14 into an analyte measurement result and to apply a temperature correction to that result based upon the signal from the thermistor 16.

FIG. 2 shows a meter 100 including a housing 102, buttons 104, a serial port 106, a display 108, a test sensor e.g. a strip 110, a strip reaction zone 112, a sample droplet e.g. interstitial fluid, plasma, blood or control solution 114 and a personal or network computer 116.

Meter 100 plus strips 110 is used for the quantitative determination of an analyte e.g. glucose in a body fluid e.g. capillary blood by health care professionals or lay persons in the home e.g. for the self monitoring of blood glucose. Results are expressed in mg/dl or mmol/l on display 108. Here, the system comprises at least one disposable reagent strip 110 and the hand-held meter 100, 102, optionally including a computer 116. The user inserts one end of a strip 110 into meter 100, 102 and places a small (circa. 1 μl) blood sample on the other end. By applying a small voltage across the blood sample and measuring the resulting electric current versus time, the meter is able to determine the glucose concentration. The result is displayed on the meter's liquid crystal display 108. The meter logs each glucose measurement typically along with a date and time stamp in a memory (not shown). The user is able to recall these measurements and using suitable internal or external software, the user may view glucose measurements on the display 108 or download glucose measurements to a PC or networked computer 116 for further analysis.

FIG. 3 shows an embodiment of a meter 200 according to the present invention, including a printed circuit board (PCB) 201, a microcontroller 202, buttons 204, a serial port (data jack) 206, a strip port 208 and a display 210. In this embodiment, microcontroller 202 has advanced digital signal processing capabilities to enable it to do the work previously done by the ASIC 14 and optionally that of the thermistor 16 (both shown in FIG. 1) as will be explained later.

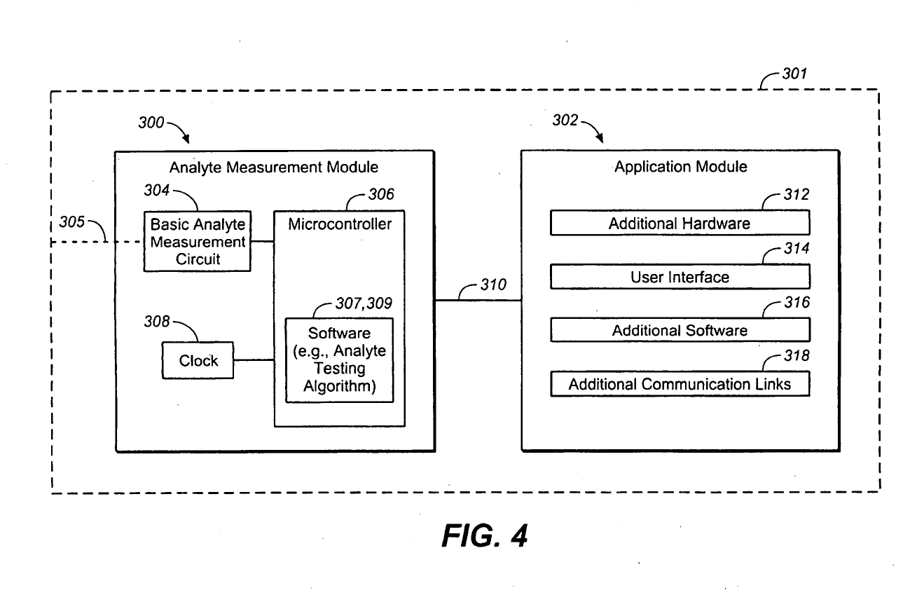

FIG. 4 shows an analyte measurement module 300, a unitary housing 301, a separate application module 302, an analyte measurement circuit 304, an optional measurement input/output line 305, a microcontroller 306, pre-loaded software 307 (e.g. firmware), a clock 308, a first analyte measurement algorithm 309, a bi-directional communication link 310, additional hardware 312, a user interface 314, additional software 316 and additional communication links 318.

Analyte measurement module 300 is connected to separate external application module 302 via bi-directional communication link 310 which may include a wire and/or a wireless connection. Analyte measurement module 300 may comprise components (software and hardware) designed to measure the concentration of glucose in blood or, for example, to measure a parameter associated with glucose or any other analyte such as HbA1C, cholesterol, etc in, for example, any body fluid, e.g. urine, blood, plasma, interstitial fluid. Analyte measurement module 300 comprises a basic analyte measurement circuit 304 arranged to conduct, for example, a test for an analyte or indicator in a sample fluid via an input/output measurement line 305 as will be explained hereinafter. For example, the test may be conducted using a test strip (item 110 in FIG. 2) for testing the concentration of glucose in blood such as the One Touch Ultra test strip available from LifeScan Inc., Milpitas, Calif., USA.

Basic analyte measurement circuit 304 is connected to and controlled by software 307 in microcontroller 306. Micro-controller 306 includes software 307 already embedded in it for testing for a particular analyte or indicator in a particular body fluid. For example, microcontroller 306 may include a blood glucose concentration algorithm 309 for determining the concentration of glucose in blood. An example of such an algorithm is already utilized in the One Touch blood glucose monitoring system (the One Touch system is available from LifeScan Inc., Milpitas, Calif., USA).

A clock 308 e.g. a crystal oscillator may also provided within the analyte measurement module 300 as an input for the microcontroller 306 to facilitate running of the software. Optionally clock 308 or an additional real time clock (not shown) functions as an input to microcontroller 306 to facilitate operation of or interaction with the basic analyte measurement circuit (e.g. a countdown during measurement).

Additional software 316 may include a second or further analyte measurement algorithms, data manipulation capability e.g. data averaging over 7, 14, 21 days, trend analysis and so on. Additional hardware 312 may include one or more PCBs, housing 301, battery capability, database, additional memory and display. Additional communication link(s) 318 may be or include wire and/or wireless capability.

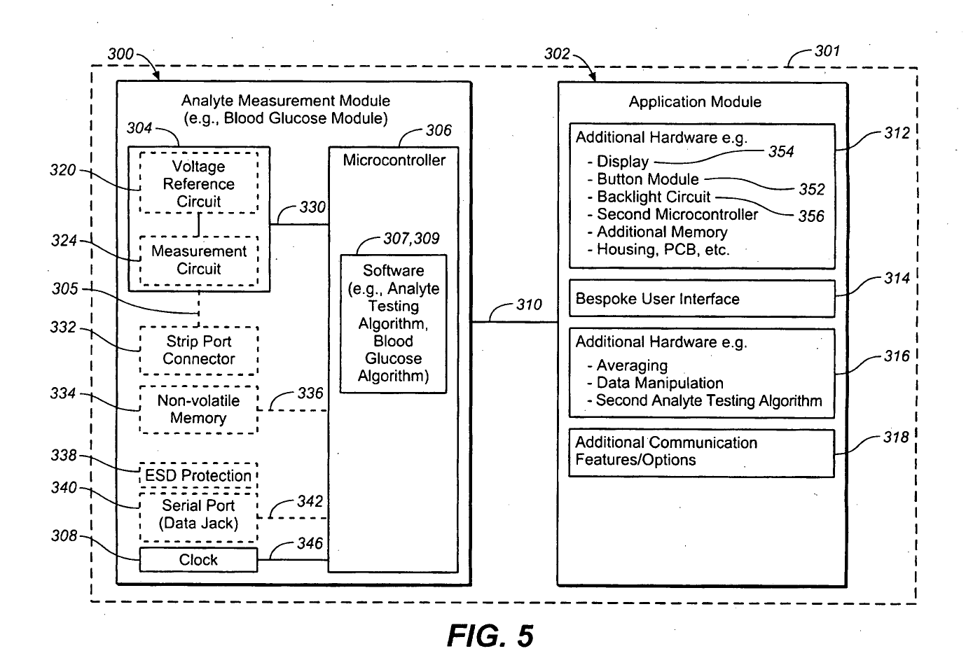

FIG. 5 shows in more detail analyte measurement module 300 and separate application module 302, here shown within a unitary housing 301. In particular, FIG. 5 shows an analyte measurement module 300 including a basic analyte measurement circuit 304, a measurement line (optionally, a measurement input and output line) 305, a microcontroller 306 and a clock 308, for example a crystal oscillator. Furthermore, FIG. 5 includes a first bi-directional communicational line (optionally wireless) 310, a separate application module 302, additional hardware 312, a user interface 314, additional software 316, additional communication links 318, a voltage reference circuit 320, a measurement circuit 324 e.g., a current to voltage converter, a measurement control/result line(s) 330, an optional strip port connector 332, an optional non-volatile memory 334 e.g., EEPROM, an optional second bi-directional communication line 336, an optional electro-static discharge protection circuit 338, an optional serial port 340 (data jack), an optional third communication line 342, an optional clock communication line 346. Any one or more dotted line item in FIG. 5 is optional.

One skilled in the art would understand that one or both of optional measurement input/output line(s) 305, bi-directional communication link 310 and/or additional communication link(s) 318 may be or include wire and/or wireless connections e.g. a serial or parallel cable, firewire cable (high speed serial cable), USB, infrared, RF, RFID, Bluetooth, WIFI (e.g., 802.11X), ZIGBEE or other communication media, protocols or data links or any combination thereof. Measurement line(s) 305 connects strip port connector 332 to measurement circuit 324. Measurement circuit 324 may be in the form of a current to voltage converter. Measurement circuit 324 may require a voltage reference input. This can be provided by voltage reference circuit 320 from which a constant reference voltage is available. Voltage reference circuit 320 may also provide a constant reference voltage to microcontroller 306 to be used by an analogue to digital converter within microcontroller 306. Measurement circuit 324 is connected to microcontroller 306 via measurement control/result line(s) 330.

Non-volatile memory 334 communicates with microcontroller 306 via bi-directional communication line 336. Thus, information such as the last result, the last n results (e.g. where n equals e.g. 50, 100, 200, 300, 400, 500), calibration code information for a particular batch of test sensors and so on can be stored. Thus, when microcontroller 306 is powered down, such information can be retained within non-volatile memory 334. It will be appreciated by those skilled in the art that whereas it is possible to have non-volatile memory 334 provided within the analyte measurement module, it is not necessary to do so. This is because the information stored within the non-volatile memory may be uploaded via bi-directional communication line 310 from other memory devices within application module 302. Indeed memory within microcontroller 306 may be used as an alternative as in the blood glucose module of FIG. 4. This latter option is less suitable if the memory is needed to operate the meter effectively even at low battery voltage, in which case a separate non-volatile memory is preferred as in FIG. 5. Storing one or more analyte measurement results within the application module is also an option, particularly if a date/time stamp is stored along with each result since optionally a real time clock is provided within additional hardware 312 within application module 302.

It would be apparent to a person skilled in the art, that analyte measurement module 300 and application module 302 could be optionally combined within an analyte measurement meter or system.

Electro-static discharge protection is provided by optional ESD protection circuit 338 to any components or lines that are thought to be vulnerable to ESD. An analogue input/output is provided by serial port 340 to and from microcontroller 306 via optional third bi-directional communication line 342. Clock 308 is connected to microcontroller 306 by clock communication line 346.

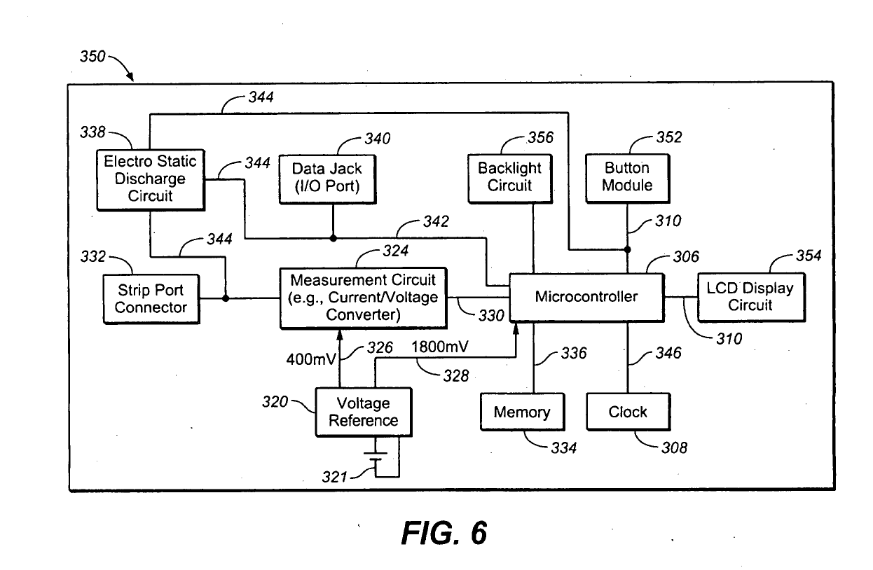

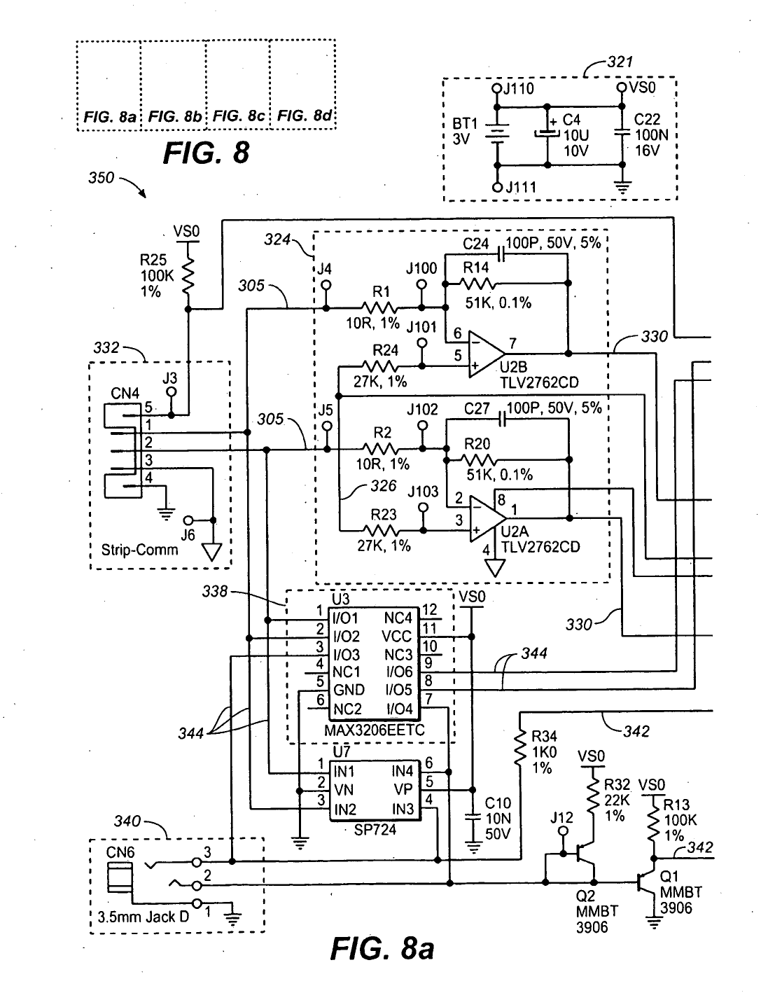

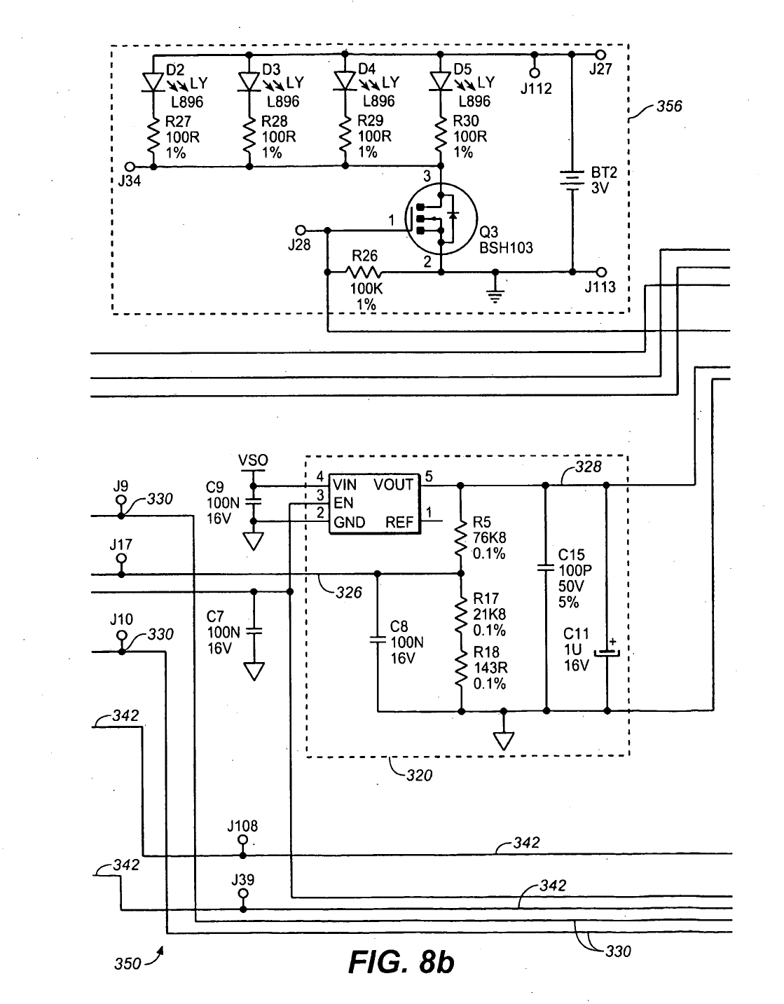

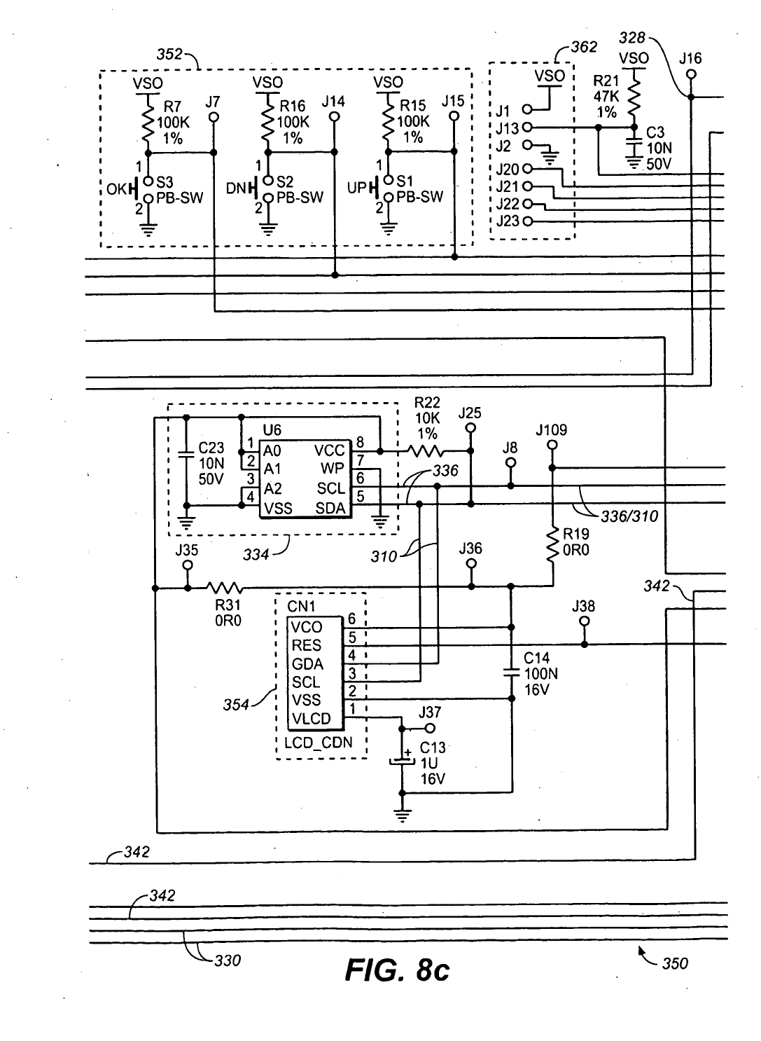

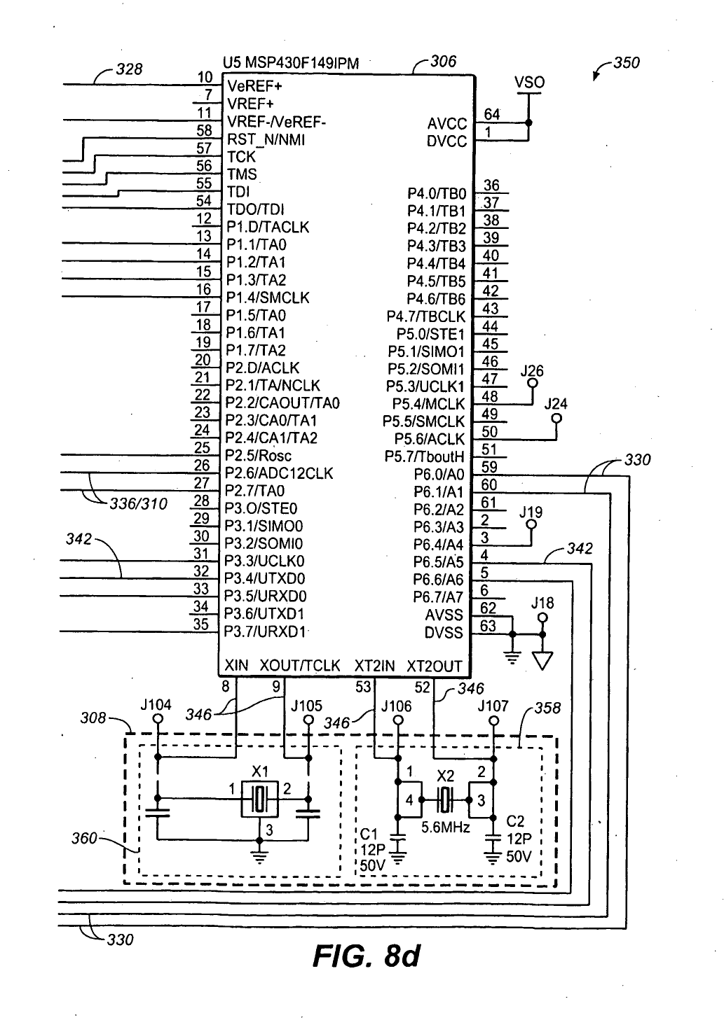

FIGS. 6 and 8A to 8D, respectively, show a block diagram and a detailed circuit diagram of a meter 350, for testing, for example, the concentration of glucose in blood using disposable test sensors in the form of test strips. Meter 350 includes a microcontroller 306, measurement line(s) 305 optionally measurement input and output lines, a clock 308, a first bi-directional communication link 310, a voltage reference circuit 320, a battery circuit 321, a measurement circuit 324 e.g. current to voltage converter, a first voltage reference line 326, a second voltage reference line 328, a measurement control/result line(s) 330, a strip port connector 332, a non-volatile memory 334, a second bi-directional communication link 336, an electro-static discharge circuit 338, an input/output port or data jack 340, a button module 352, an LCD display circuit 354 and a backlight circuit 356.

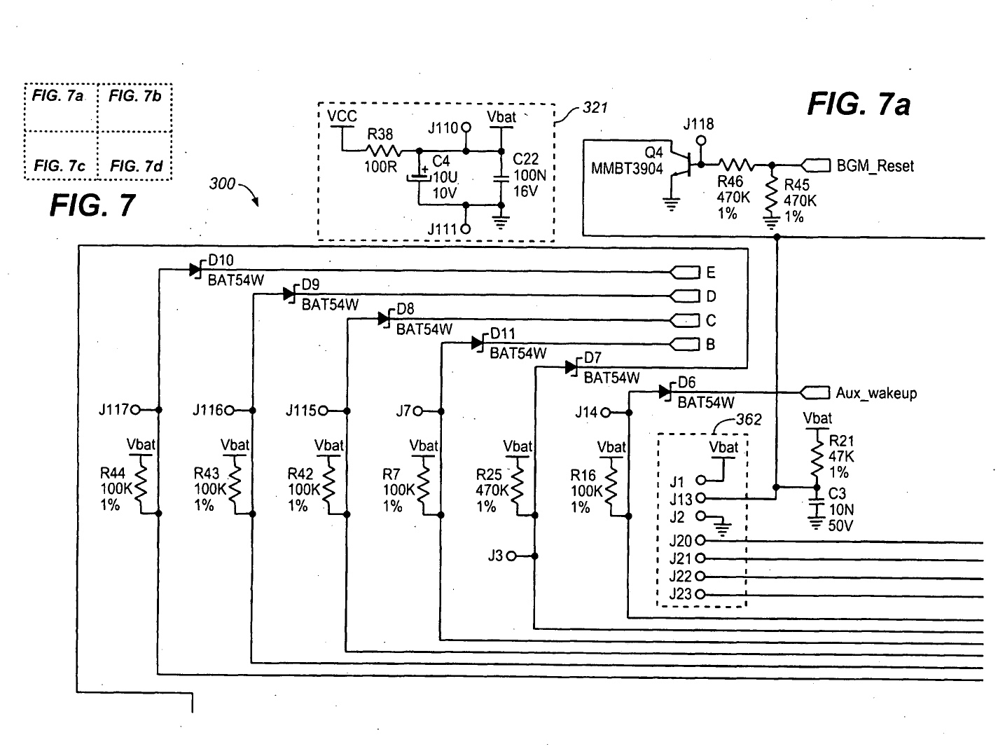

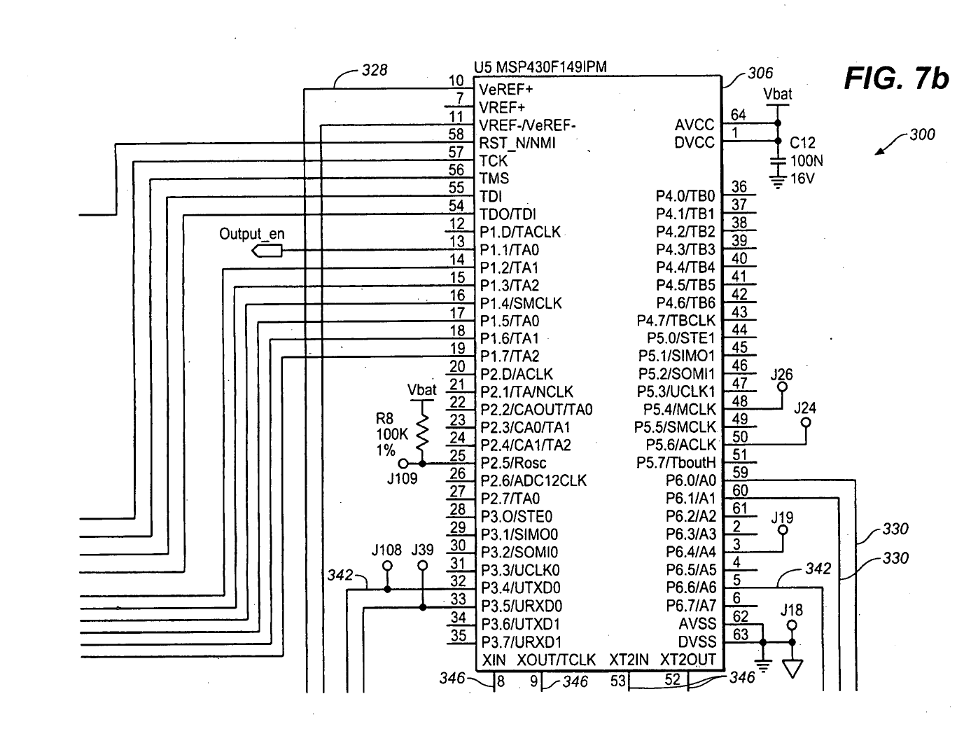

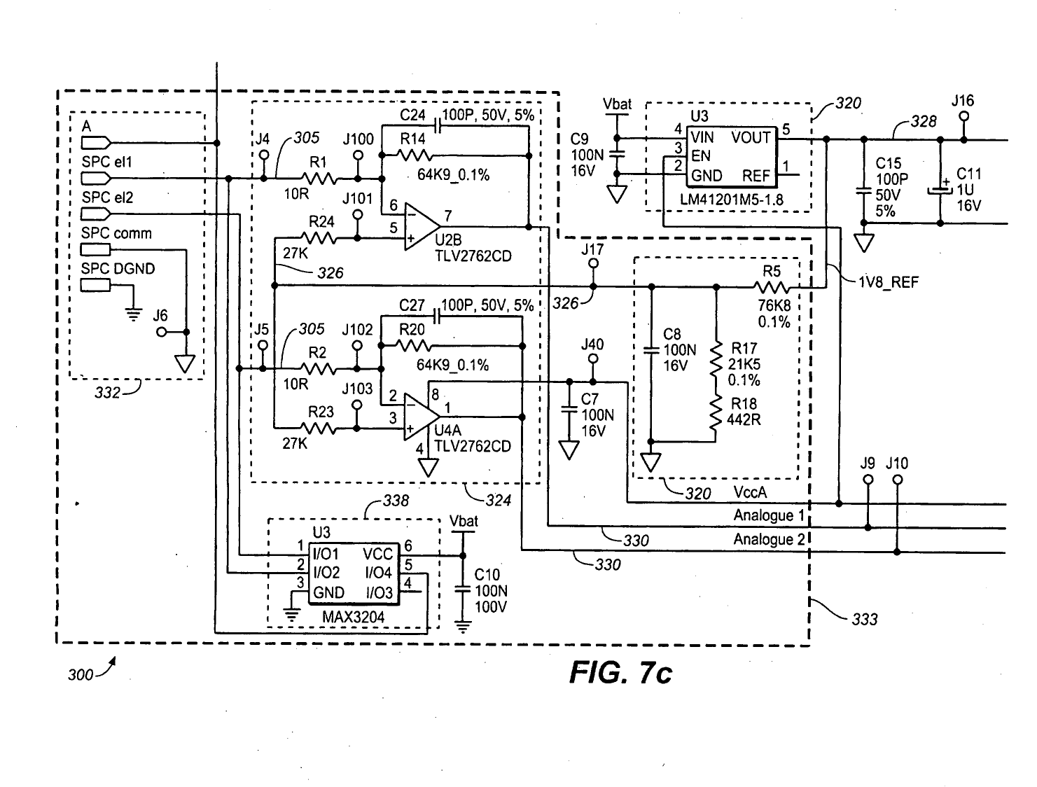

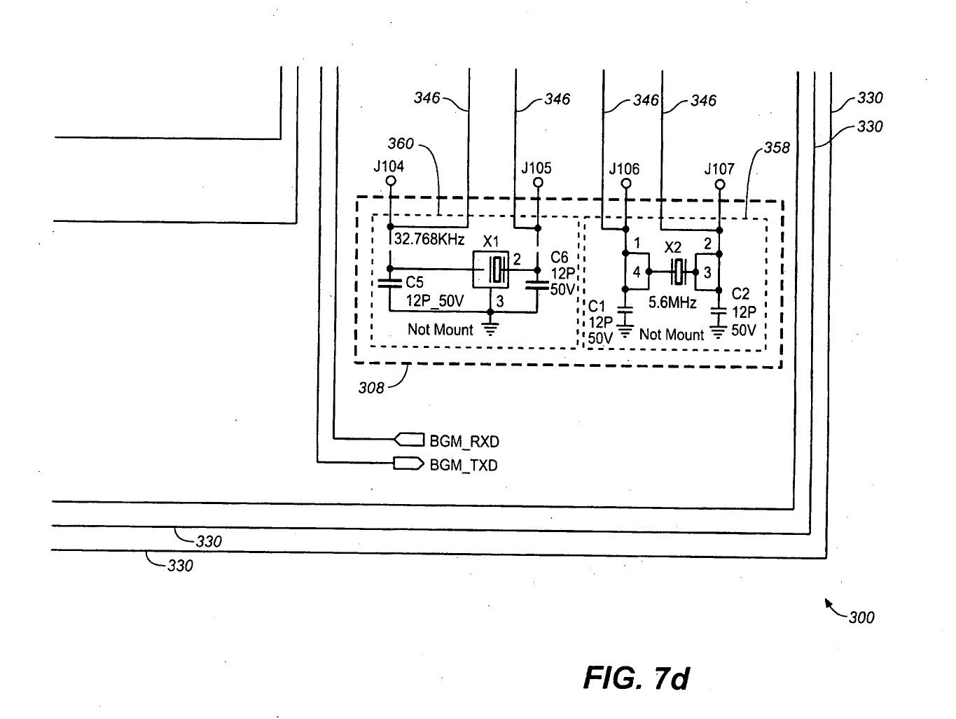

FIGS. 7A to 7D shows a detailed circuit diagram of a blood glucose module according to one example embodiment of the invention. Analyte measurement module 300 seen in FIGS. 7A to 7D includes a microprocessor 306, a clock circuit 308, a first oscillator circuit 358, a second oscillator circuit 360, a voltage reference circuit 320, a battery circuit 321, programmable nodes 362, an ESD protection circuit 338, a measurement circuit 324, a strip port connector circuit 332, a PCB with mounted components 333, a first voltage reference line 326, a second voltage reference line 328 and a reset circuit “BGM-reset”.

Referring briefly to FIGS. 7A to 7D, there is shown an example of a blood glucose module 300, measurement line(s) 305 optionally measurement input and output lines, a microcontroller 306, a clock 308, a voltage reference circuit 320 (two parts), a battery circuit 321, a measurement circuit 324, voltage reference lines 326, 328, a measurement control/result line(s) 330, strip port connector connection points 332, components to be mounted on separate PCB 333, an ESD protection Circuit 338 (U3 on FIGS. 7A to 7D), a first oscillator circuit 358, a second oscillator circuit 360, programming nodes 362, and a set of pull up resistors R16, R25, R7, R42, R43 and R44 and diodes D6, D7, D11, D8, D9, D110 on corresponding wake up lines Aux Wake up, B, C, D and E and on a line or ESD Protection Circuit 338 (U3 on FIGS. 7A to 7D).

It can be seen from FIGS. 6 and 8A to 8D that strip port connector 332 is connected to measurement circuit 324. A voltage reference circuit 320 provides voltage references such as a 400 mV reference voltage in the case of a One Touch Ultra strip to measurement circuit 324. Voltage reference circuit uses a voltage reference integrated circuit e.g. LM41201M5-1.8 available from National Semiconductors. This is a very accurate voltage reference integrated circuit and it has a very good temperature coefficient (50 ppm/° C.). Measurement circuit 324 supplies a voltage reference of 400 mV, for example, on two separate lines to pins 1 and 2 on the strip port connector 332. Measurement circuit 324 uses two operational amplifiers U2B and U2A e.g. a dual amplifier 1.8V micropower Rail to Rail such as a TLV2762CD available from Texas Instruments. Strip port connector 332 may be the same used as in the One Touch Ultra meter available from LifeScan Inc, Milpitas, Calif., USA. Typically, the strip to be inserted in strip port connector 332 can form two electrochemical circuits by means of a first working electrode and a second working electrode each with reference to a single reference electrode on the test strip. A typical test strip is the One Touch Ultra test strip available from LifeScan Inc., Milpitas, Calif., USA.

For example, non-volatile memory 334 is a 24256 available from ATMEL Semi-conductors. Display circuit 354 and non-volatile memory use an I²C interface allowing these both to be connected to the same ports or microprocessor 306 but addressed separately by microcontroller 306.

Microcontroller 306 may be from the family of MSP 430x13x, MSP 430x14x, MSP 430x14x1 microprocessors, such as the MSP 430F133, MSP 430F135, MSP 430F147, MSP-430F1471, MSP 430F148, MSP 430F1481, MSP 430F149, MSP 430F1491 available from Texas Instruments, Dallas, Tex. These microcontrollers have a range of memory from 8 KB+256 B Flash and 256 B RAM to 60 KB+256 B Flash and 2 KB RAM.

In addition, an on-chip temperature sensor optionally in the form of a silicon temperature diode on microcontroller 306 is optionally used in place of a separate thermistor. The temperature sensor on microcontroller 306 has a linear response to temperature change (3.55 mV/° C. plus or minus 3%) over the range of operation of microcontroller which is well in excess of the 0-50° C. typical operating ranges of analyte meters and systems and can be used to determine the temperature. A temperature compensation factor can then be applied to the analyte measurement result either following application of the analyte measurement algorithm or as part of the algorithm within the microcontroller 306.

Thus microcontroller 306 has the ability to measure the ambient temperature internally using a silicon temperature sensor. This type of temperature sensor has increased accuracy and linearity compared to a typical thermistor.

Clock 308 comprises two oscillator circuits, a fast oscillator circuit 358 at for example 5.8 Mhz and a slow oscillator circuit 360 at for example 32.76 kHz. The oscillator circuit at 32.76 kHz is always on and is used to provide a real time clock feature which allows a time and date stamp information to be affixed to a result e.g. a glucose concentration measurement. Oscillator circuit 358 is used to run the software on the microcontroller 306 at the appropriate speed.

The circuit of FIGS. 8A to 8D of a meter 350 will now be described in more detail. Pin 1 of strip port connector circuit 332 is connected to the negative input of an operational amplifier U2B in measurement circuit 324 via a resistor R1. In addition, pin 1 of strip port connector or circuit 332 is connected to pin 2 of electrostatic discharge integrated circuit 338. Also, pin 2 of strip port connector 332 is connected via resistor R2 to the negative input of another operational amplifier U2A within measurement circuit 324 and to pin 1 of electro-static discharge integrated circuit 338. Pin 3 of strip port connector 332 is connected to analogue ground and pin 4 of strip port connector 332 is connected to digital ground. In addition, pin 5 of strip port connector 332 is connected to a voltage supply rail via resistor R25.

The integrated circuit within voltage reference circuit 320 has two outputs, both from pin 5. The first output connects to the positive inputs of the first and second operational amplifiers of measurement circuit 324 via resistors R5, R17, R18, R23 and R24. Resistors R5, R17 and R18 provide a potential divider with the resultant reference voltage being 400 mV. Additionally, voltage reference circuit 320 delivers a voltage reference of 1800 mV to pin 10 of microcontroller 306. The outputs from the first and second operational amplifiers of the measurement circuit 324 are connected to pins 59 and 60 respectively of microcontroller 52 by measurement result line(s) 330. Furthermore the outputs from operational amplifiers of measurement circuit 324 are also connected to the negative inputs of the operational amplifiers of the measurement circuit in an inverting feedback configuration. Capacitor C24 and C27 provide filtering to reduce noise within the inverting feedback loop. Pin 3 of voltage reference circuit 320 is connected to a switchable power supply voltage and also to one or both of the operational amplifiers in measurement circuit 324 (see pin 8 of lower operational amplifier). Pin 2 of voltage reference circuit 320 is connected to analogue ground.

Electro-static discharge circuit 338 contains an integrated circuit such as Max 3204 or Max 3206, for example, input ESD protection array available from Maxim, California, USA. Electro-static discharge circuit 338 is connected to the microcontroller 306 by lines 344 and 342 (see FIG. 6). In addition, serial port 340 is connected to microcontroller 306 by communication line 342 and to electro-static discharge protection circuit 338. Furthermore, optional ESD protection is provided by ESD circuit 338 on the lines connecting each of strip port connector 332, the serial port 340 and the button module 352 to the microcontroller 306. These three items are often touched or approached by a user and therefore are more susceptible to electro-static damage, hence the use of ESD protection circuit 338 on these lines.

Four light emitting diodes with associated resistors are connected in parallel within backlight circuit 356. These diodes are controlled by a field effect transistor BSH103 available from Phillips Electronics and powered by a separate battery as described in co-pending patent application “Scheme for providing a backlight in a meter” (DDI5068 by the same applicant filed herewith). The field effect transistor is controlled by pin 31 on microcontroller 306.

Switches within button module 352 are connected via ‘pull-up’ resistors to pins 13, 14, 16 on microcontroller 52. A non-volatile memory circuit 334 (IC 24256 available from ATMEL Semi-conductors) is connected to pins 26 and 27 in microcontroller 306. Crystal oscillators within clock circuits 358 and 360 connect between pins 8 and 9 and between pins 52 and 53 on microcontroller 306.

As has been seen in FIGS. 6 and 8A to 8D measurement module 304 includes a voltage reference circuit 320 and a measurement circuit 324. Measurement circuit 324 is supplied with a power rail 326 of typically 400 mV for example. Measurement circuit 324 contains at least two operational amplifiers U2A and U2B as previously described. The operational amplifiers within measurement circuit 324 receive the voltage reference (400 mV) at their positive input from voltage reference circuit 320. The operational amplifiers buffer this voltage enabling 400 mV to be delivered to the strip port connector without loading the voltage reference circuit 320. Also at least one and typically both of the operational amplifiers is in negative feedback mode so that the output of 400 mV is adjusted until there is no significant difference between the positive and negative inputs of the operational amplifier. One operational amplifier is utilized as a current to voltage converter that converts the current drawn from working electrode 1 (pin 1 on strip port connector circuit 332) into a voltage which is fed back to the microprocessor 306 as shown in FIG. 7 along line(s) 330. This is achieved by connecting pin 1 of the SPC 332 to the negative input (V⁻in) of operational amplifier U2B along with the output (Vo/p) from the operational amplifier U2B (optionally via a resistor K). The reference voltage is supplied to the positive input (V⁺in) of operational amplifier U2B. Thus, the operational amplifier U2B acts to maintain a minimal voltage difference between its inputs by raising its output voltage to compensate for the current drawn. Thus the output voltage is equal to the reference voltage plus the current multiplied by the resistance between the output and the negative input (Vin≅V⁺in therefore Vo/p=Vref+I×R) where I is the current drawn by the SPC 332 (and hence the test strip). In a similar manner, the other operational amplifier U2A is used as a current to voltage converter to convert the current drawn from working electrode 2 (pin 2 on strip port connector circuit 332) into a voltage which is fed to the microprocessor 306 as shown in FIGS. 8A to 8D along line(s) 330.

Measurement circuit 324 applies a voltage of 400 mV to each of the first and second working electrodes on the test strip and measures the current drawn between these working electrodes and a reference electrode on the strip (connected to pin 3 of the strip port connector 332). The current drawn from one or two working electrodes on the test strip is fed into the microcontroller as one or two analogue voltages by measurement control/result line(s) 330. An analogue to digital converter within microcontroller 306 converts these into digital signals. Microcontroller 306 is optionally a 16 bit or greater microcontroller optionally a mixed signal microprocessor capable of receiving and processing both analogue and digital signals.

Pre-loaded software within microcontroller 306 optionally includes a blood glucose algorithm and a temperature correction algorithm. The blood glucose algorithm is used to convert the current measured at one working electrode, or an average current at two working electrodes together with elapsed time, into a glucose concentration. Next, the temperature diode inbuilt on the microcontroller 306 gives a temperature measurement and allows the temperature compensation algorithm to be applied to the result.

Typically the measurement circuit 324 delivers a voltage representative of the current drawn from the measurement circuit to the microcontroller 306 rather than a current. The microcontroller then converts this voltage to a value akin to a current to provide a current transient response with respect to time. The current developed after 5 seconds is converted into a glucose concentration using a known formula and calibration code information, the formula is of the form Y=MX+C where X is time, Y is current at 5 seconds and M and C are calibration constants typically retrieved from the non-volatile memory.

Button module 352 controls the operation of the user interface 314. LCD display 354 displays the results from the microcontroller 306. Backlight circuit 356 can be operated via button module 352 and microcontroller 306 to enhance the view on the LCD display 354. Button Module 352 is used to manipulate the user interface as described in co-pending application “Blood Glucose Monitor User Interface” (DDI5061 by the same applicant filed herewith) the entire contents of which are hereby incorporated by reference. In one embodiment button module 352 includes 3 buttons (“OK”, “UP” and “DOWN”). Optionally, the OK button can be used to switch the meter on by depressing it for a few seconds, and/or select an item highlighted by a cursor on the display 354 and/or toggle ON/OFF the backlight by depressing it for a few seconds as well as being used to discharge the capacitors in the VSO circuit during battery changing as described below. Similarly, optionally the “UP” and “DOWN” buttons also can be used in more than one way.

Each button is connected to the voltage supply by a pull up resistor R7, R16 and R15 in FIG. 8C and to the microprocessor via port P1 and in particular by pins P1.4, P1.2 and P1.1. Thus, any of these buttons can be depressed for a few seconds after battery removal from the meter to aid discharge of the capacitors C4 and C22 in voltage supply circuit VSO. C4 is the larger of the two capacitors at 10 μF and is more likely to require additional discharging than C22 at 100 nF. Typically pull-up resistors are around 100 kΩ although it is possible to set one at a lower value, say 10 kΩ to aid faster discharge of the capacitors on the voltage supply for example during battery changing. Discharge of the capacitors in this way reduces the possibility of a switch off action followed by a quick switch on action by a user being of insufficient duration to allow discharge of the capacitors. Without sufficient time or other action to discharge, the capacitors may continue to apply voltage to the microcontroller 306 via the voltage supply input on pin 64 and pin 1 with the potential result that the microcontroller 306 may hang due to this spurious input voltage from the capacitors. Use of one or more buttons to facilitate quick discharge should provide a solution to this.

It should be understood that various alternatives to the embodiments of the invention described herein may be employed in practicing the invention. It is intended that the following claims define the scope of the invention and that methods and structures within the scope of these claims and their equivalents be covered thereby.

1-3. (canceled)

4. A circuit for analyte measurement in a biological fluid sample, the circuit comprising:
a test strip connector having a measurement line configured to be connected to a working electrode of a test strip and a reference line configured to be connected to a reference electrode of the test strip to a ground; and
an operational amplifier provided with a line voltage from a voltage reference circuit to provide a reference voltage to the working electrode of a test strip without loading the voltage reference circuit, and the output of the operational amplifier is configured to compensate for any current drawn by an electrochemical cell formed by the working electrode and reference electrode.

5. A circuit for analyte measurement in a biological fluid sample, the circuit comprising:
a test strip connector having a measurement line configured to be connected to a working electrode of a test strip and a reference line configured to be connected to a reference electrode of the test strip to a ground; and
an operational amplifier having a first input connected to a voltage reference circuit and a second input connected to both the working electrode and to an output of the operational amplifier via a feedback resistor.

6. The circuit according to claim 5, in which the working electrode comprises a second working electrode connected to another operational amplifier with a line voltage from a voltage reference circuit to provide a reference voltage to the second working electrode of a test strip without loading the voltage reference circuit, and the output of the another operational amplifier is configured to compensate for any current drawn by an electrochemical cell formed by the second working electrode and reference electrode.

7. The circuit according to claim 4, in which the operational amplifier comprises a first input connected to the voltage reference circuit and a second input connected to the working electrode, feedback resistor, and an output of the operational amplifier.

8. The circuit according to claim 5, further comprising a noise filter connected in parallel to the feedback resistor.

9. The circuit according to claim 5, in which the another operational amplifier comprises a first input connected to the voltage reference circuit and a second input connected to the second working electrode, feedback resistor and an output of the operational amplifier.

10. The circuit according to claim 5, further comprising a noise filter connected in parallel to the feedback resistor.

11. A circuit for analyte measurement in a biological fluid sample, the circuit comprising:
a test strip connector having a measurement line configured to be connected to a working electrode of a test strip and a reference line configured to be connected to a reference electrode of the test strip to a ground; and
an operational amplifier having first and second inputs and an output, the first input provided with a line voltage and the second input connected to the working electrode to the measurement line, a feedback resistor, and the output so that the output provides a voltage indicative of a current drawn by an electrochemical cell formed by the working electrode and the reference electrode.

12. The circuit according to claim 10, in which the working electrode comprises a second working electrode connected to another operational amplifier with a line voltage from a voltage reference circuit to provide a reference voltage to the second working electrode of a test strip without loading the voltage reference circuit, and the output of the another operational amplifier is configured to compensate for any current drawn by an electrochemical cell formed by the second working electrode and reference electrode.

13. A system to determine analyte concentration in a biological fluid sample, the system comprising:
a test strip connector having a measurement line configured to be connected to a working electrode of a test strip and a reference line configured to be connected to a reference electrode of the test strip, the reference line also being connected to a ground;
a voltage reference circuit that provides a line voltage;
a buffer circuit connected to the reference circuit to provide a reference voltage substantially equal to the line voltage to the measurement line without loading the voltage reference circuit, the buffer circuit having an output connected to the measurement line via a feedback resistor; and
a processing circuit connected to the output of the buffer circuit so as to provide a voltage indicative of the current drawn from an electrochemical cell when such cell is formed by the working electrode and reference electrode of the test strip in the presence of a fluid sample.

14. The system according to claim 13, in which the buffer circuit comprises:
an operational amplifier having a first input connected to the voltage reference circuit and a second input connected to the working electrode, feedback resistor and an output of the operational amplifier.

15. The system according to claim 13, in which the test strip connector comprises a second working electrode.

16. The system according claim 15, in which the buffer circuit comprises:
a second operational amplifier having a first input connected to the voltage reference circuit and a second input connected to the second working electrode, feedback resistor and an output of the operational amplifier.

17. The system according to claim 14, in which a filter is connected in parallel to the feedback resistor.

18. A method of measuring analyte concentration in a biological fluid sample, the method comprising:
providing a test strip having a working electrode and a reference electrode;
connecting the reference electrode to a ground;
depositing a fluid sample across the electrodes;
supplying a reference voltage substantially equal to a line voltage of an electrical power source to the working electrode in which the reference voltage is independent of a load on the electrical power source; and
measuring a change in current between the working electrode and the reference electrode generated by the reference voltage, the change in current being indicative of an analyte concentration in the biological fluid sample.

19. The method of claim 18, in which the supplying comprises connecting a first input of an operational amplifier to the line voltage and a second input to both the working electrode and an output of the operational amplifier via a feedback resistor.

20. The method of claim 18, in which the working electrode comprises first and second working electrodes.

21. The method of claim 18, in which the supplying comprises:
connecting a first input of an operational amplifier to the line voltage and a second input to both the first working electrode and an output of the operational amplifier via a feedback resistor; and
connecting a first input of another operational amplifier to the line voltage and a second input to both the second working electrode and an output of the another operational amplifier via a feedback resistor.
